(19) United States
(12) Patent Application Publication
(10) Pub. No.: US 2006/0234054 A1
(43) Pub. Date: Oct. 19, 2006

(54) Building material for erection or renovation of a construction, in particular dykes and use and method for production thereof

(76) Inventor: Oskar Hauke, Willingen (DE)

Correspondence Address: Striker Striker & Stenby, 103 East Neck Road, Huntington, NY, 11743, US

(21) Appl. No.: 10/530,591

(22) PCT Filed: Oct. 9, 2003
(86) PCT No.: PCT/DE03/03407

§ 371 Date: Oct. 7, 2005

(30) Foreign Application Priority Data
Oct. 10, 2002 (DE) 102 47 744.2

(51) Int. Cl. B32B 1/00

(52) U.S. Cl. 428/403; 428/404

(57) ABSTRACT

A material for the erection or renovation of constructions, in particular dykes is disclosed, essentially comprising a surface treatment made from a sand or rock flour and made waterproof by means of a hydrophobic agent. The material is preferably packed in plastic sacks and produced in a mixer, by mixing suitable amounts of sand and/or rock flour with hydrophobic agent.

The invention relates to a building material for erecting or restoring structures, in particular dikes or levees, and a use and a method for its production.

To prevent flooding and flood damage during heavy rainfall, snow melting or the like it is customary to raise flood protection dams in the form of permanent dikes or levees. As a result of increasing development and consequently built-up areas as well as for numerous other reasons it is not always desirable to erect such levees along rivers, in particular not in situations where the maximum high water level would necessitate permanent dikes/levees having a height of several meters.

The non-existence of dikes may result in the flooding of entire urban districts and country regions, unless countermeasures are undertaken in good time in the event of a critical rise in the water level.

A generally known, traditionally applied and comparatively inexpensive method to avoid flood catastrophes and resulting flood water damage is the temporary erection of dikes with the aid of bags and other receptacles filled with sand, concrete waste or the like. Although it is possible to achieve effective protection by using such methods, it quite frequently happens that the dikes thus erected collapse or at least become leaky. The main reason for this is that the water easily penetrates the fill material consisting of sand or the like, which then softens and becomes deformed, and that the sealing effect of the erected dike, at least locally, is ultimately impaired thereby. This occurs in particular where bags made of jute or other easily degradable materials are used to hold the loose bulk fill material. As a consequence, protective dams or the like made by using sand bags must be monitored constantly for their effectiveness and leaky areas must be repaired immediately in order to prevent major large-area dike collapses.

Similar disadvantages are encountered in the protection and renovation of building structures such as for instance structures classified as historical monuments. In such cases it is often desirable to use mineral materials available as fill which on the one hand are insusceptible against the penetration of moisture or wetness even when permanently placed in masonry, walls or the like and, on the other hand can be produced, incorporated and processed in a cost-effective manner.

Proceeding on this assumption, the present invention provides a solution to the technical problem posed, namely to propose a suitable building material for the construction or sealing or repair of dikes and other water-repellent or water-storing structures which can be packaged and handled similar to sand and comparable fill material but has significantly superior sealing properties and resistance to water. Furthermore, uses and a method for the production of the building material will be proposed.

The solution to the problem is a building material which essentially consists of sand, powdered minerals or a mixture of the two which have been made water-repellent by means of a hydrophobing agent. Hydrophobing agents which are suitable are preferably an inexpensive calcium stearate as well as soy oil or tall oil. A use and a method for the production of the building material are described in claims 7 and 13 respectively.

The invention offers the substantial advantage that the sand or the powdered minerals or their individual grains are water-repellent due to their surface having been treated with a hydrophobing agent. This means that water drops will drain off the grains without wetting them and that receptacles filled with such building material, in particular flexible bags, form a barrier which is not easily penetrated by water. By contrast to normal sand, a sand provided with a hydrophobic coating by means of a hydrophobing agent does not even in the long run soften in water, so that dam collapses are effectively counteracted and buildings can be protected against the penetration or leakage of liquids. The same applies when powdered minerals are used which have been rendered hydrophobic.

Further advantageous features of the invention are described in the dependent claims.

The preferred powdered rock is limestone. The broken rock fragments obtained by means of blasting (for instance large diameter hole blasts) are coarsely crushed by means of a rock drill bit or the like and then conveyed to a rock breaker. In this process, the coarsely crushed material is conveyed to a breaker in a first cleaning step carried out for instance by means of shake-out grids and then screened in further vibrating screens. Following a fine grinding step, for instance in a ball mill, the material is conveyed to air separators or the like for the preparation of a finely ground flour (for instance 10 to 40 μm) which is then conveyed towards the hydrophobing step. If required, severely soiled powdered rock can be subjected to a further cleaning step prior to the hydrophobing process. The hydrophobing or surface coating of an entire grain size fraction is then carried out in a mixing plant by adding stearates (for instance calcium stearate) or suitable oils. Depending on its composition, the hydrophobing agent may be added as a powder or in liquid form, obtained for instance by preheating to 80° C. to 100° C. The production of building materials made from other types of rock is carried out in the same manner.

An adequate hydrophobing of sand or powdered minerals is already achieved where the portion of the hydrophobing agents is only approx. 1 to 2% by weight. Particularly advantageous is the use of sand or powdered minerals having a grain size of less than approx. 200 μm, i.e. fine to very fine sand or fine to very fine powdered mineral. In this case a very dense, compact material is obtained which offers a high flow resistance to water even following penetration of any packaging layer which may be present.

Besides calcium stearate, soy oil and tall oil—the latter being a by-product created during the production of wood pulp from resin-rich kinds of wood, such as for instance spruce or pine—it is of course possible to use for the specified purpose also other suitable hydrophobing agents and/or mixtures of the afore mentioned or other hydrophobing agents, such as for instance rape oil.

The production of the building material described is carried out preferably by mixing in a mixer preselected quantities of sand and/or powdered rock and hydrophobing agents for an adequate period, for instance 5 to 20 minutes. The surface treatment of the sand or powdered rock grains thus achieved leads to their hydrophobing, resulting in the specified attributes. Preferred mixers are positive paddle mixers such as for instance counter current mixers.

### EXAMPLE

In one embodiment example, sand was used as the starting material. 50 kg of this sand having a grain size of 20 μm max. which was obtained by screening the sand in an air separator, were treated for 10 minutes with 1 kg calcium stearate in a positive mixer which included milling balls which can be set into vibration. A hydrophobic, water-repellent loose bulk fill was thus obtained.

The duration of the mixing process for the surface treatment should be selected in dependence of the grain size used and should be longer for fine grain than for coarse grain.

Besides sand (for instance dry river, sea or desert sand) numerous powdered minerals (for instance obtained from marble, dolomite, granite, quartzite, feldspar, serpentine, basalt, diabas, barite, gypsum, lime or kaolin) may be used which are all crystalline, natural minerals and not amorphous rock glass such as for instance perlite or even expanded perlite or the like.

When using a liquid hydrophobing agent such as for instance tall oil, rape oil or the like, the liquid component can also be added by spraying it into the starting material.

The building material in accordance with the invention is preferably packaged in easy-to-handle quantities in bags or, if required, in mats or the like subdivided into segments, which bags or mats are made of a non-degradable material such as for instance polyvinyl chloride foil and are used in the same way as conventional sand bags for the erection or repair of levees/dikes. After the flood waters have receded, the bags filled with the building material in accordance with the invention are again collected and stored. The risk of decay is much lower than compared with that of easily degradable jute bags which moreover are comparatively more expensive.

A further use for the building material in accordance with the invention can consist in already existing or newly to erect dike or other building structures, such as for instance a protective dam or levee, to be provided with a core of the hydrophobed building material. An already existing dike can for instance be excavated by means of a drag shovel to the desired width and depth—which preferably reach to below the ground water level—and then filled with a hydrophobed sand or powdered mineral to form the core zone. The lateral boundaries in old and new structures are appropriately covered with a foil (for instance PVC) which is a non-degradable or not easily degradable foil and, if required, secured with additional support elements and subsequently built up in the customary manner. To allow for the monitoring of the dike structures, water level indicators can be additionally built in. It is understood that the hydrophobed building material can also be built into the dike structures, with the aid of a suitable machine, in the form of a loose fill packaged in comparatively large receptacles or in the form of comparatively large, prefabricated building elements. Furthermore, the core zones can be constructed of several layers for the sake of earth quake protection.

Apart from this, it is also possible, depending on the specific use, to package the building material described in bags of degradable, at least slightly porous fabrics, in particular bags made of jute fabric or the like instead of packaging them in PVC bags, in particular where a later removal with subsequent re-use of the bags is not required.

Furthermore, the use of valve bags can be advantageous, since in this case a simple, inexpensive filling is possible at different sites and with filling machines having filling nozzles which are insertable into the valves. The use of porous packaging has the advantage that the building material can penetrate into the pores of the packaging material and thereby produce a hydrophobic effect also on the outer surfaces of the packaging.

A further advantageous use of the building material in accordance with the invention, irrespective of whether or not the area is prone to flooding, is directed to the protection of historical monuments. In such applications, it is possible to package the described building material in the form of slabs/panels, surface elements (web rolls) or the like and to use it in this form as building elements or blocks for the erection of permanent walls or the like.

Furthermore the building material described can be inserted into cavities of buildings or subsoils thereof, in that it is converted into a liquid or powdered form and similar to gunniting by means of compressed air or the like can be pressed into spaces which are inaccessible or very difficult to access, which for instance can be boreholes previously placed in building structures to be renovated.

The term ,,dikes“ within the scope of the invention shall include any suitable kind of protective dams, walls or the like irrespective of whether the dike structures in question are permanently or temporarily required protective dams.

The building material in accordance with the invention can furthermore be used for the removal, reduction and prevention of ground water damage as well as against any water damage of any kind, including frost damage, as well as for the renovation or sealing of cracked exterior walls of buildings. In the latter case, the building material can be inserted into the masonry for instance by compressed air or with the aid of liquid substances which are volatilised after the application.

Finally, the building material in accordance with the invention, in an analogous manner, can also be used for water storage (water retention) in that it is applied for sealing or enclosing of permanent or mobile pools and ponds, water basins, storage cisterns or the like.

The invention is not limited to the embodiment examples described, which can be modified in numerous ways. This relates in particular to the specified quantities of hydrophobing agent during the surface treatment. Depending on the type of hydrophobing agent and the desired extent of the hydrophobing effect, greater or lesser amounts than 1 to 2% by weight can be admixed to the mixture present in the mixer. Furthermore the hydrophobing effect can be achieved with other methods than those specified and also with other hydrophobing agents than those specified. Furthermore, the building material in accordance with the invention can be applied not only in the bagged form or otherwise packaged form but also in the fired form, for instance in that it is placed in suitable moulds and made into solid building components and is then fired. Furthermore it is understood that the different features can be applied also in other combinations than those described.

1. A building material for erecting or restoring water-repellent and water-storing building structures, in particular dikes/levees, essentially consisting of a sand and/or powdered mineral which has been rendered water-repellent by means of a surface treatment with a hydrophobing agent.

2. The building material in accordance with claim 1, characterised in that it contains 1 to 2% by weight of calcium stearate as the hydrophobing agent.

3. The building material in accordance with claim 1, characterised in that it contains tall oil, soy oil or rape oil as the hydrophobing agent.

4. The building material in accordance with claim 1, characterised in that it has a grain size smaller than 200 μm.

5. The building material in accordance with claim 1, characterised in that the powdered mineral consists of natural, broken rock.

6. The building material in accordance with claim 1, characterised in that it is produced essentially from a powdered mineral containing calcium carbonate.

7. A use of a material essentially consisting of a sand and/or powdered mineral, which has been rendered water-repellent by means of a surface treatment with a hydrophobing agent, for erecting or restoring building structures, in particular dikes/levees.

8. The use in accordance with claim 7, characterised in that the material is in the form of a loose bulk material filled into a receptacle.

9. The use in accordance with claim 8, characterised in that the material is packaged in a bag made of a flexible plastic material, in particular polyvinyl chloride.

10. The use in accordance with claim 8, characterised in that the receptacle is a valve bag.

11. The use in accordance with claim 8, characterised in that the receptacle is made of a porous material.

12. The building structure, in particular a dike/levee, characterised in that for the protection against the penetration of liquid it contains at least one core zone which is produced by means of a material in accordance with claim 1 and/or by means of a receptacle in accordance with claim 8.

13. A method for the production of a material in accordance with claim 1, characterised in that the sand and/or the powdered mineral is rendered water-repellent by preselected quantities of sand and/or powdered mineral and hydrophobing agent being mixed in a mixer for a time period which is selected in dependence of the grain size.

14. The method in accordance with claim 12, characterised in that the powdered mineral is produced from natural, broken rock by way of the rock being crushed/reduced in size and cleaned prior to the hydrophobing process.
